(19) United States
(12) Patent Application Publication
(10) Pub. No.: US 2013/0286849 A1
(43) Pub. Date: Oct. 31, 2013

(54) METHOD AND APPARATUS FOR TRANSMITTING AND RECEIVING MEASUREMENT PATTERN IN COMP COMMUNICATION SYSTEM

(71) Applicant: Kyoungmin Park, Seoul (KR)

(72) Inventor: Kyoungmin Park, Seoul (KR)

(73) Assignee: PANTECH CO., LTD., Seoul (KR)

(21) Appl. No.: 13/978,521

(22) PCT Filed: Jan. 4, 2012
(86) PCT No.: PCT/KR12/00096

§ 371 Date: Jul. 5, 2013

(30) Foreign Application Priority Data
Jan. 7, 2011 (KR) 10-2011-0001995

(51) Int. Cl. H04W 24/06

(52) U.S. Cl. CPC H04W 24/06
USPC 370/241

(57) ABSTRACT

A method of transmitting a measurement pattern for a signal transmission/reception in a CoMP communication system, so as to provide Coordinated Multi-Point (CoMP) communication to a first User Equipment (UE) by a first evolved Node-B (eNB) and a second eNB, the method includes setting a second ABS pattern for a signal transmission/reception with a second UE transmitting/receiving a signal to/from only the first eNB for a predetermined period by the first eNB; setting a first ABS pattern, which corresponds to a subset of the second ABS pattern, as a pattern for a signal transmission/reception with the first UE; setting the subset of the first ABS pattern as a measurement pattern and transmitting the measurement pattern to the first UE; and transmitting a signal for the CoMP communication system according to the measurement pattern.

### CROSS-REFERENCE TO RELATED APPLICATIONS

This application is the National Stage Entry of International Application PCT/KR2012/000096, filed on Jan. 4, 2012, and claims priority from and the benefit of Korean Patent Application No. 10-2011-0001995, filed on Jan. 7, 2011, both of which are incorporated herein by reference in their entireties for all purposes as if fully set forth herein.

### BACKGROUND

1. Field

The present invention relates to a wireless communication system, and more particularly to a coordinated multi-point communication system and method, in which each eNB includes two or more transmission antennas and one or more base stations receive channel information from a User Equipment (UE) to perform multiple antenna transmissions in a coordinated multi-point communication system.

2. Discussion

With the development of a communication system, consumers such as enterprises and individuals have used highly various wireless terminals.

Accordingly, communication service providers continuously attempt to create a new communication service market for the wireless terminals and provide a service having a low price but reliability to expand a conventional communication service market.

Introduction of various technologies is considered to increase a communication capacity of a wireless communication system. When new technologies are introduced to the conventional wireless communication system, the correlation between an increased capacity due to the introduction of the new technologies and a decreased communication capacity of a conventional user or a former terminal due to the introduction of the new technologies should be first considered. That is, a compatibility with a conventional system should be considered, and a method of maximally expanding a capability of a new system is required.

### SUMMARY

Additional features of the invention will be set forth in the description which follows, and in part will be apparent from the description, or may be learned by practice of the invention.

In accordance with an aspect of the present invention, there is provided a method of transmitting a measurement pattern for a signal transmission/reception in a Coordinated Multi-Point (CoMP) communication system, so as to provide Coordinated Multi-Point (CoMP) communication to a first User Equipment (UE) by a first evolved Node-B (eNB) and a second eNB, the method comprising setting a second Almost Blank Subframe (ABS) pattern for a signal transmission/reception with a second UE transmitting/receiving a signal to/from only the first eNB for a predetermined period by the first eNB; setting a first ABS pattern, which corresponds to a subset of the second ABS pattern, as a pattern for a signal transmission/reception with the first UE; setting the subset of the first ABS pattern as a measurement pattern and transmitting the measurement pattern to the first UE; and transmitting a signal for the CoMP communication system according to the measurement pattern.

In accordance with another aspect of the present invention, there is provided a method of transmitting a measurement pattern for a signal transmission/reception in a CoMP communication system, so as to provide Coordinated Multi-Point (CoMP) communication to a first User Equipment (UE) by a first evolved Node-B (eNB) and a second eNB, the method comprising setting a second ABS pattern for a signal transmission/reception with a second UE transmitting/receiving a signal to/from only the first eNB for a predetermined period by the first eNB; transmitting information on the second ABS pattern to the second eNB; receiving information on a first ABS pattern, which corresponds to a subset of a third ABS pattern for a signal transmission/reception with a third UE transmitting/receiving a signal to/from only the second eNB for a predetermined period, from the second eNB and setting the received first ABS pattern as a pattern for a signal transmission/reception with the first UE; setting a subset of the first ABS pattern as a measurement pattern and transmitting the measurement pattern to the first UE; and transmitting a signal for the CoMP communication system according to the measurement pattern.

In accordance with another aspect of the present invention, there is provided a method of receiving a measurement pattern for a signal transmission/reception in a CoMP communication system, so as to perform Coordinated Multi-Point (CoMP) communication with a first evolved Node-B (eNB) and a second eNB by a first User Equipment (UE), the method comprising receiving a measurement pattern, which corresponds to a subset of a first ABS pattern, from the first eNB; and measuring a signal transmitted from the first eNB and the second eNB according to the measurement pattern and transmitting a measurement result to one or more eNBs of the first eNB and the second eNB, wherein the first ABS pattern corresponds to a subset of a second ABS pattern for a signal transmission/reception with a second UE transmitting/receiving a signal to/from only the first eNB for a predetermined period.

In accordance with another aspect of the present invention, there is provided a method of receiving a measurement pattern for a signal transmission/reception in a CoMP communication system, so as to perform Coordinated Multi-Point (CoMP) communication with a first evolved Node-B (eNB) and a second eNB by a first User Equipment (UE), the method comprising receiving a measurement pattern, which corresponds to a subset of a first ABS pattern, from the first eNB; and measuring a signal transmitted from the first eNB and the second eNB according to the measurement pattern and transmitting a measurement result to one or more eNBs of the first eNB and the second eNB, wherein the first ABS pattern corresponds to a subset of a second ABS pattern for a signal transmission/reception with a second UE transmitting/receiving a signal to/from only the second eNB for a predetermined period.

In accordance with another aspect of the present invention, there is provided an eNB in a wireless communication system including a first eNB and a second eNB, which provide CoMP communication to a first UE, the eNB comprising a transmitting/receiving unit for transmitting a signal for a CoMP communication system according to a measurement pattern; a pattern setting unit for setting a second ABS pattern for a signal transmission/reception with a second UE transmitting/receiving a signal to/from only the first eNB for a predetermined period and setting a first ABS pattern, which corresponds to a subset of the second ABS pattern, as a pattern for a signal transmission/reception with the first UE; and a controller for controlling such that the transmitting/receiving unit sets a subset of the first ABS pattern as a measurement pattern and transmitting information on the measurement pattern to the first UE, wherein the ABS pattern includes information indicating a subframe through which a signal is transmitted and received.

In accordance with another aspect of the present invention, there is provided an eNB comprising a first eNB and a second eNB, which provide a CoMP to a first UE in a wireless communication system, the eNB comprising a transmitting/receiving unit for transmitting a signal for a CoMP system according to a measurement pattern; a pattern setting unit for setting a second ABS pattern for a signal transmission/reception with a second UE transmitting/receiving a signal to/from only the first eNB for a predetermined period; and a controller for controlling such that the transmitting/receiving unit transmits information on the second ABS pattern to the second eNB, wherein the transmitting/receiving unit receives information on a first ABS pattern, which corresponds to a subset of a third ABS pattern for a signal transmission/reception with a third UE transmitting/receiving a signal to/from only the second eNB for a predetermined period from the second eNB and the pattern setting unit sets the first ABS pattern as a pattern for a signal transmission/reception with the first UE, the controller controls such that the transmitting/receiving unit sets a subset of the first ABS pattern as a measurement pattern and transmits the measurement pattern to the first UE, and the ABS pattern includes information indicating a subframe through which a signal is transmitted and received.

In accordance with another aspect of the present invention, there is provided a UE performing CoMP communication with a first eNB and a second eNB, the UE comprising a receiver for receiving a measurement pattern, which corresponds to a subset of a first ABS pattern, from the first eNB; a controller for measuring signals transmitted from the first eNB and the second eNB according to the measurement pattern; and a transmitter for transmitting a measurement result to one or more eNBs of the first eNB and the second eNB, wherein the UE is a first UE, the first ABS pattern corresponds to a subset of a second ABS pattern for a signal transmission/reception with a second UE transmitting/receiving a signal to/from only the first eNB for a predetermined period, and the measurement pattern includes information indicating a subframe through which a signal is transmitted and received.

In accordance with another aspect of the present invention, there is provided a UE performing CoMP communication with a first eNB and a second eNB, the UE comprising a receiver for receiving a measurement pattern, which corresponds to a subset of a first ABS pattern, from the first eNB; a controller for measuring signals transmitted from the first eNB and the second eNB according to the measurement pattern; and a transmitter for transmitting a measurement result to one or more eNBs of the first eNB and the second eNB, wherein the UE is a first UE, the first ABS pattern corresponds to a subset of a second ABS pattern for a signal transmission/reception with a second UE transmitting/receiving a signal to/from only the second eNB for a predetermined period and the measurement pattern includes information indicating a subframe through which a signal is transmitted and received.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a CoMP communication system to which embodiments of the present invention are applied.

FIG. 2 is a diagram illustrating another CoMP communication system to which embodiments of the present invention are applied.

FIG. 3 illustrates an example of avoiding interference in a heterogeneous network to which an embodiment of the present invention is applied.

FIG. 4 illustrates a process of transmitting a measurement pattern to avoid interference in a heterogeneous network to which an embodiment of the present invention is applied.

FIG. 5 illustrates an example of a transmission between an eNB and a UE according to an ABS pattern in an eICIC situation to which an embodiment of the present invention is applied.

FIG. 6 illustrates an example of allocating resources when three types of UEs coexist according to an embodiment of the present invention.

FIG. 7 illustrates a signaling between a UE operated through an eICIC scheme and a UE operated through a CoMP scheme to which an embodiment of the present invention is applied.

FIG. 8 illustrates an example of a transmission between an eNB and a UE according to an ABS pattern in CoMP and eICIC situations to which an embodiment of the present invention is applied.

FIG. 9 illustrates a process in which a UE receives a measurement pattern for a CoMP transmission generated by an embodiment of the present invention to measure a channel and a link.

FIG. 10 illustrates an example of a measurement pattern and a CoMP transmission pattern, which can be generated through an embodiment of the present invention.

FIG. 11 illustrates a process in which an eNB performing a CoMP transmission according to an embodiment of the present invention generates a measurement pattern to provide the generated measurement pattern to a UE.

FIG. 12 illustrates a process in which an eNB performing a CoMP transmission according to an embodiment of the present invention generates a measurement pattern to provide the generated measurement pattern to a UE.

FIG. 13 illustrates that a UE performing a CoMP transmission according to an embodiment of the present invention receives a measurement pattern to measure a signal according to the received measurement pattern.

FIG. 14 illustrates that a UE performing a CoMP transmission according to an embodiment of the present invention receives a measurement pattern to measure a signal according to the received measurement pattern.

FIG. 15 illustrates a construction of an eNB according to an embodiment of the present invention.

FIG. 16 illustrates a construction of a UE according to an embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

Further, terms or words used herein should not be understood to limit the terms or words to a general meaning or a dictionary meaning, and should be understood as a meaning and a concept, which accord with a technical idea of the present invention and by which an inventor can explain his/her invention in the best manner based on a principle the present invention may be properly defined through the concept.

The present invention relates to a wireless communication system, and a method and an apparatus for transmitting a measurement pattern in order to not generate interference between UEs having various transmission patterns.

Further, the present invention intends to reduce signal interference between a UE or an eNB and another UE in a CoMP communication system and improve the transmission efficiency.

In mobile communication systems such as current 3GPP, LTE (Long Term Evolution), and LTE-A (LTE Advanced), it is required to develop a technology, which can transmit high capacity data which can be transmitted in a wired communication network, as a high speed and high capacity communication system, which can transmit and receive various data such as image and radio data, beyond services mainly for voice. Further, it is necessary for such a technology to have a proper error detecting method, which can minimize an information loss and increase a system efficiency thereby improving a system capability.

Meanwhile, a communication system using MIMO (multiple-Input Multiple-Output) antennas is used in both transmitting and receiving terminals, and the communication system has a structure in which Single UE (SU) or Multiple UEs (MU) share the same capacity of radio resources and receive or transmit a signal from or to one eNB

In a system using a MIMO, it is required to implement a process of grasping a channel state by using a reference signal, and feeding back the grasped result to a transmission port (another device).

That is, when one UE is allocated a plurality of downlink physical channels, the UE may feedback channel state information for each physical channel to a base station to adaptively optimize a system. For the optimization, a Channel Status Index-Reference Signal (CSI-RS), a Channel Quality Indicator (CQI) signal, and a Precoding Matrix Index (PMI) signal may be used. An eNB can use the channel state related information to schedule a channel

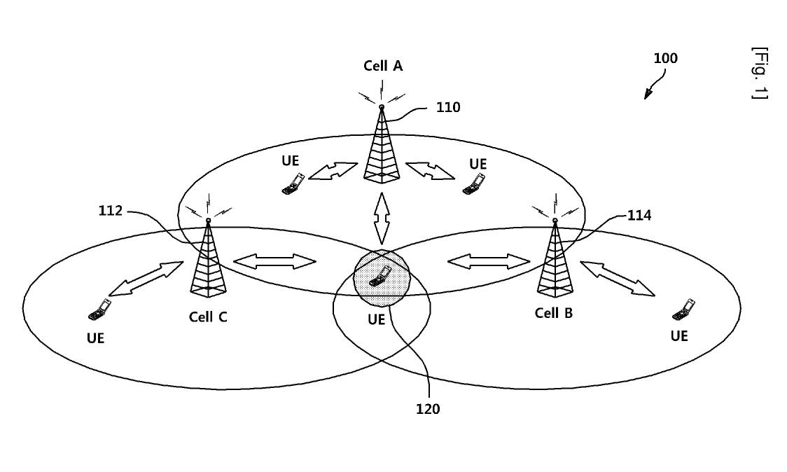

FIG. 1 is a diagram illustrating a coordinated multi-point system to which embodiments of the present invention are applied.

A coordinated multi-point system 100 of FIG. 1 is characterized as transmitting a signal through two or more coordinated transmission ports. An example of the Coordinated Multi-Point (hereinafter, referred to as “CoMP”) communication system includes a coordinated multi-point transmission/reception system, and a coordinated multi-antenna transmission system.

The CoMP communication system 100 to which embodiments of the present invention are applied corresponds to a CoMP communication system for transmitting a signal through two or more coordinated transmission ports. Each transmission port includes two or more transmission antennas and one or more transmission ports receive channel information from a reception port, so that multiple antenna transmission may be achieved.

In the CoMP communication system 100, when two or more eNBs, for example, three eNBs 110, 112, and 114 attempt a coordinated multi-point transmission/reception to one UE 120, the same frequency resources are allocated to the same time resources and a service is implemented. That is, the three eNBs 110, 112, and 114 selected as coordinated multi-point eNBs can transmit/receive data to/from the one UE 120 at the same time by using the same frequency resources.

UEs using the above communication scheme may be UEs having a low intensity of a signal in comparison with cells located in a center area of cells because the UEs are located in an inter cell edge area, or may be UEs, which can receive a signal from two or more eNBs, because the UEs have a relatively close distance from another eNB. In a heterogeneous network (Het-Net) in which eNBs having different sizes of cell coverage are overlapped, even a UE, which is not located in a cell edge, can receive a signal from two or more eNBs (for example, one pico-cell eNB and one macro-cell eNB) through a network structure. When two or more eNBs cooperatively transmit a signal to such UEs, the UEs can acquire better capabilities in comparison with a conventional case where the UE receives a signal from one eNB. At this time, two eNBs can cooperate with each other or three or more eNBs can cooperate with each other. Further, the coordinated scheme may be applied to a Multi User-Multiple Input Multiple-Output (MU-MIMO) scheme as well as a Single User-Multiple Input Multiple-Output (SU-MIMO) scheme.

CoMP communication system 100 may be widely arranged to provide various communication services such as voice and packet data.

The UE 120 in this specification is a generic concept indicating a user terminal in wireless communication, and should be interpreted as a concept including all of a MS (Mobile Station), a UT (User Terminal), a SS (Subscriber Station), and a wireless device in a GSM as well as a UE (User Equipment) in a WCDMA, a LTE, and an HSPA.

The one UE 120 can be simultaneously connected to two or more eNBs 110, 112, and 114 to receive a service, and can be connected to an eNB having the best channel according to a channel state on a regular cycle to receive a service. Accordingly, an eNB selected as a coordinated multi-point eNB should be a eNB having a good channel capability for a certain frequency band with respect to one UE.

The eNBs (evolved Node-Bs) 110, 112, and 114 or a cell refer to a fixed station communicating with the UE 120, and may be referred to as other terms such as a Node-B, a BS (Base Station), a BTS (Base Transceiver System), and an access point.

The eNBs 110, 112, and 114 or a cell should be interpreted as a generic concept indicating some areas covered by a BSC (Base Station Controller) in a CDMA and a Node-B in a WCDMA, and is a concept including various coverage areas such as communication ranges of a mega cell, a macro cell, a micro cell, a pico cell, and a femto cell.

The UE 120 and the eNBs 110, 112, and 114 in the present specification are used as a generic meaning, which are transmitting/receiving subjects used to implement a technology or a technological idea described in the present disclosure, and they are not limited by a specifically designated term or word.

A multiple access scheme applied to a wireless communication system has no limitation, and the wireless communication system can use various multiple access schemes such as a CDMA (Code Division Multiple Access), a TDMA (Time Division Multiple Access), an FDMA (Frequency Division Multiple Access), an OFDMA (Orthogonal Frequency Division Multiple Access), an OFDM-FDMA, an OFDM-TDMA, and an OFDM-CDMA.

An embodiment of the present invention may be applied to resource allocations of asynchronous wireless communication evolving into an LTE (Long Term Evolution) and an LTE-advanced via a GSM, a WCDMA, and an HSPA, and synchronous wireless communication evolving into a CDMA, a CDMA-2000, and a UMB. The present invention should not be interpreted to be limited and restricted to a specific wireless communication field, but should be interpreted to include all technical fields, to which ideas of the present invention can be applied.

One or more transmission ports can cooperatively transmit a signal in order to provide a signal having a higher strength to a UE located in a shadow area, or a weak cell or a sector boundary area having a relatively low signal strength, and reduce inter cell interference or more effectively use radio resources. The transmission port may be a transmission port included in different eNBs and may be a transmission port serving a different cell included in the same eNB.

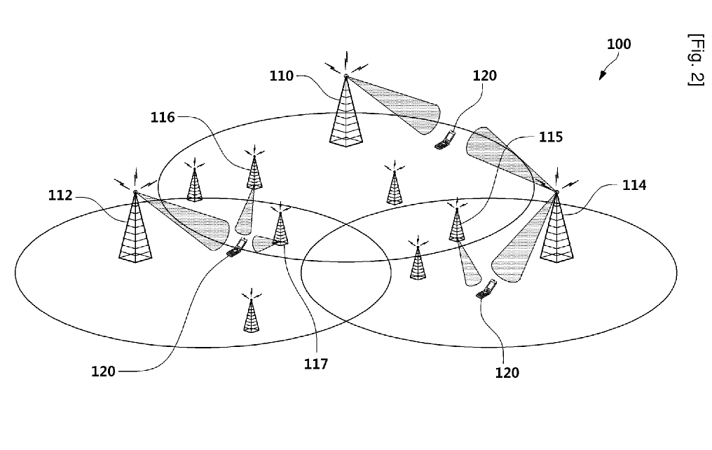

FIG. 2 is a diagram illustrating another CoMP communication system to which embodiments of the present invention is applied.

Referring to FIG. 2, in another CoMP communication system 100 to which embodiments of the present invention are applied, an eNB performing coordinated communication with the UE 120 may be the macro eNBs 110, 112, and 114 shown in FIG. 1. Further, an eNB performing coordinated communication with the UE 120 may be various types of micro or local eNBs such as a femto cell 115, a pico cell 116, a relay 117, and a hot spot 118 located within cell coverage. As shown in FIG. 2, a network configured by various types of eNBs is referred to as a heterogeneous network.

When each transmission port includes a transmission antenna and a MIMO transmission is possible, the CoMP communication system 100 can acquire more excellent capability through not only coordinated communication between the macro eNBs 110, 112, and 114 but also coordinated communication between eNBs having different driving characteristics such as the micro eNB or the pico eNB 115, 116, or 117.

Meanwhile, if a value of a beam-performing or a precoding is set in consideration of a channel state only with an existing eNB providing a service of a beam forming or a precoding in performing the beam-forming or the precoding, an eNB in the CoMP communication system can set the value of the beam-forming or the precoding by estimating an estimation value or an interference value for the channel state.

Referring FIGS. 1 and 2, the UE 120 can analyze reference signals transmitted from the respective eNBs 110 to 117 to grasp a channel state for each antenna of the respective eNBs 110 to 117. After grasping the channel state, the UE 120 directly or indirectly feeds back the information to each eNB 120. The eNBs 110 to 117 receiving feedback of the information or a higher layer select eNBs having a good channel capability to establish a coordinated eNB set or a CoMP set and eNBs included in the coordinated eNB set or the CoMP set initiate a coordinated transmission/reception.

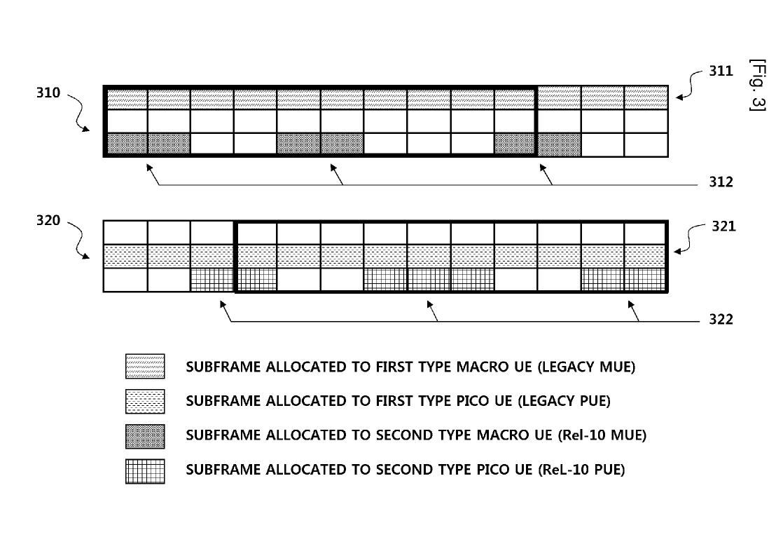

FIG. 3 illustrates an example of avoiding interference in a heterogeneous network to which an embodiment of the present invention is applied.

FIG. 3 shows an embodiment of measurement patterns of a macro eNB and a pico eNB for an eICIC (enhanced InterCell Interference Coordination) transmission. The measurement pattern refers to information on a Reference Signal (RS) position containing position information of a subframe in which a reference signal should be measured to measure a state of a channel or a link. FIG. 3 illustrates a transmission pattern 310 of the macro eNB and a transmission pattern 320 of the pico eNB. Four types of UEs may exist within the macro/pico eNB of FIG. 3. A first type UE following LTE Rel-8, 9 may be divided into a first type macro UE (legacy MUE) and a first type pico UE (legacy PUE) according to whether the first type UE is connected to the macro eNB or the pico eNB. An operation through an eICIC scheme does not support the first type UE following LTE Rel-8, 9.

Meanwhile, a second type UE following LTE-Advanced Rel-10 is divided into a second type macro UE (Rel-10 MUE) and a second type pico UE (Rel-10 PUE) according to whether the second type UE is connected to the macro eNB or the pico eNB. The division of the first type UE and the second type UE is to distinguish UEs using different communication systems implemented or applied in one wireless system, and the division is not certainly limited to the LTE, the LTE-Advanced, or the Rel-8, 9 or the Rel-10.

The transmission pattern 310 of the macro eNB is divided into two patterns for a frequency band 311 allocated to the first type macro UE and a frequency band allocated to the second type macro UE. Accordingly, the first type macro UE can avoid interference with a signal transmitted/received from/by the second type macro UE.

Similarly, the transmission pattern 320 of the pico eNB is divided into two patterns for a frequency 321 allocated to the first type pico UE (when the first type pico UE exists) and a frequency band allocated to the second type pico UE. Accordingly, the first type pico UE can avoid interference with a signal transmitted/received from/by the second type pico UE.

Referring to the transmission patterns 310 and 320, it can be seen that the first type macro UE and the first type pico UE have different frequency bands through which signals are transmitted and received. Meanwhile, it can be seen that the second type macro UE and the second type pico UE have different time bands through which signals are transmitted and received. Accordingly, when the UEs transmit and receive data with each of the macro/pico eNBs, the data is transmitted at different times, so that inter cell interference can be reduced.

More specifically, an eNB or a cell (macro-macro or macro-pico) shares areas and loads with which they should deal. In general, some of loads or areas are shared between macro-macro and all loads or areas of the pico eNB are shared with the macro eNB between macro-pico. More specifically, in a system to which the eICIC scheme is not applied, the macro eNB and the pico eNB should use distinguished bands. However, in a system to which the eICIC scheme is applied, the macro eNB and the pico eNB can use the same frequency band on different time axes. Accordingly, the macro eNB and the pico eNB can adaptively divide radio capacities to be used by each eNB according to the load of each cell and use them for a Rel-10 UE. However, between a Rel-8, 9 UE and the Rel-10 UE, the same operation as that in the Rel-10 is not possible. When a Rel-11 UE operated with the CoMP is applied to the system in the same way as described above, each macro/pico eNB performs a process of first dividing a band to be used by the Rel-8, 9 UE, a frequency band to be used by the Rel-10 UE, and a frequency band to be used by the Rel-11 CoMP UE, and allocating radio resource capacities according to macro-pico cell loads on a time axis within a frequency band used by the Rel-10 UE or the Rel-11 UE. For a more free radio capacity utilization or allocation than the above method, an embodiment of the present invention uses a method in which the Rel-10 eICIC UE and the Rel-11 CoMP UE allocate time axis resources in the same manner, so that the Rel-10 UE and the Rel-11 CoMP UE can use the same frequency band. That is, in a wireless network system where various types of UEs coexist, radio resources may be shared and divided on a time axis by using a pattern. In this case, a transmission pattern may be determined by considering a transmission amount of an eNB or a cell. Further, such a pattern is shared between eNBs or cells through an X2 interface, and a scheduling for each eNB or each cell may be performed within the pattern. The transmission patterns 310 and 320 correspond to examples for showing transmission patterns between macro-pico eNBs. In the transmission patterns 310 and 320, there are areas in which data is not transmitted or received in a transmission pattern used by each eNB (macro or pico), and the areas are referred to as an ABS (Almost Blank Subframe). An ABS pattern indicates the ABS areas. The ABS areas mean that transmission power is set to a value approximated to “0” or transmission power is reduced to decrease interference in a corresponding subframe. A signal transmission is not performed in a band to which an ABS pattern of a corresponding subframe is applied.

Meanwhile, a position of a subframe in which each UE will perform a link estimation or a channel estimation is determined according to a pattern used by each cell. Each eNB notifies each UE of a measurement pattern for the link estimation or the channel estimation. The measurement pattern includes position information of a subframe in which a Reference Signal (RS) should be measured for measuring a channel state or a link state. Each UE measures a channel state or a link state from a RS according to the notified measurement pattern and transfers the measured channel or link states to the eNB. Hereinafter, a pattern includes position information of a subframe in which a specific operation is scheduled to be performed or a specific operation is scheduled not to be performed.

In short, in FIG. 3, UEs, which access a macro cell and a pico cell for an interference control between the macro cell and the pico cell, respectively, use different frequency bands to access an eNB as shown in reference numerals 311 and 321 when the first type UE (UE before Rel-9) requests to access the eNB in a heterogeneous network where a macro cell and a pico cell coexist. A frequency band to be used by the first type UE (UE before Rel-9) accessing the macro cell and the first type UE (UE before Rel-9) accessing the pico cell may not be randomly determined by each eNB, and the frequency band may be semi-statically changed through an agreement between eNBs or may be fixed.

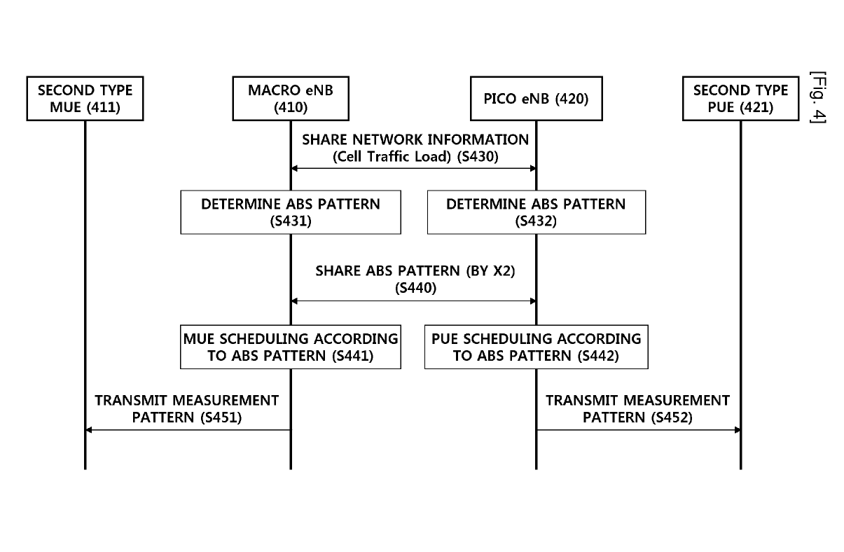

The second type UE (UE before Rel-10) uses a different frequency band from the first type macro UE and the first type pico UE to access an eNB. Further, between the macro eNB and the pico eNB transmitting a signal or information to the second type UE, time division schemes 312 and 322 are used so that inter cell interference may be avoided between the macro eNB and the pico eNB. While information on the ABS pattern used by each eNB does not have to be transferred to each UE, a measurement pattern according to a transmission pattern has to be transferred to a corresponding UE. A process of transferring the measurement pattern is illustrated in FIG. 4.

FIG. 4 illustrates a process of transmitting a measurement pattern to avoid interference in a heterogeneous network to which an embodiment of the present invention is applied. FIG. 4 shows a process of sharing network information between the macro eNB and the pico eNB to determine an ABS pattern and transmitting a measurement pattern to each of UEs according to the determined ABS pattern. More specifically, the process shown in FIG. 4 shows an example for a signaling for an eICIC implementation.

A macro eNB 410 and a pico eNB 420 share network information S430. A process of sharing network information means, for example, that information on network resources required according to a traffic load of a cell is shared. That is, both eNBs share information on a communication state through an X2 interface and predetermine a section in which each eNB can transmit a signal based on the shared information. In the process, each eNB determines a section in which data or a signaling is transmitted not to generate data conflict in a transmission process and shares information on the determined section. At this time, a determined pattern may be referred to as an ABS pattern or a subframe pattern. As shown in FIG. 4, each eNB determines an ABS pattern S431 and S432. Further, the macro eNB 410 and the pico eNB 420 share a corresponding ABS pattern by using the X2 interface S440. Accordingly, that is, the macro eNB 410 and the pico eNB 420 share an eICIC subframe pattern and information on the pattern. At this time, information shared by using the X2 interface is shared between eNBs and not notified to a UE.

Further, the macro eNB 410 and the pico eNB 420 can schedule to receive measurement patterns of UEs included in their cells according to the shared ABS pattern S441 and S442. Next, each eNB determines subframes in which a signal can be transmitted within their cells by using the determined ABS pattern, determines measurement patterns suitable for the transmission pattern, and transmits the measurement patterns to accessed UEs. That is, the macro eNB 410 and the pico eNB 420 transmit the measurement pattern created according to a scheduling result generated by using the ABS pattern S451 and S452. The measurement pattern is for a pattern for a channel measurement and a link measurement and an embodiment of the measurement pattern may include i) a pattern for measuring a link connection state of a serving cell, ii) a pattern for measuring a channel state of a serving cell, iii) a pattern for measuring a link state of a neighboring cell (cell for a handover), and iv) a pattern for measuring a channel state of a neighboring cell. The patterns iii) and iv) for the neighboring cell may be represented as one pattern.

A reason why the measurement pattern is notified is that a UE accessing the pico eNB cannot receive a signal in a first subframe and a second subframe and only interference generated by a signal of the macro eNB is detected in the subframes when the pattern shown in FIG. 3 is used for the eICIC. Further, a third subframe and a fourth subframe can receive a signal of the pico eNB without interference generated due to the macro eNB. A UE accessing a cell controlled by the pico eNB through the subframe pattern can communicate without interference generated due to the macro eNB, but the UE cannot acquire direct information (on the ABS pattern) on a subframe in which a signal is transmitted by each eNB, so that a UE accessing the pico eNB notifies the eNB that there is very strong interference when the UE measures a channel in the first subframe. Accordingly, in an eICIC operation, it is required for each eNB to inform a UE of information on a subframe in which the UE should measure a channel state and a link state or information on reference signal resources to be used for information and the measurement for the subframe.

When applying FIG. 4, the macro UE 411 and the pico UE 421, which are the second type UEs (to which Rel-10 is applied), receive a measurement pattern from eNBs in which UEs 411 and 421 are combined through steps S451 and S452, and can measure a link connection state and a channel state of a serving cell or a neighboring cell according to the corresponding pattern.

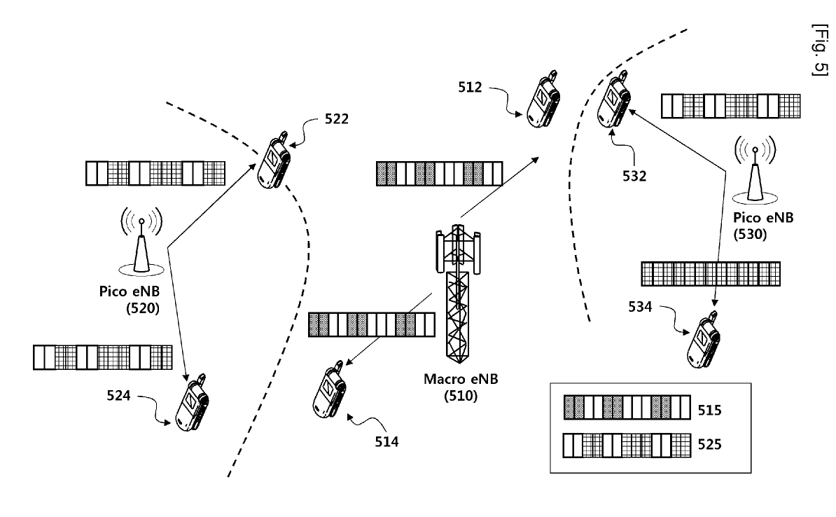

FIG. 5 illustrates an example of a transmission between an eNB and a UE according to an ABS pattern in an eICIC situation to which an embodiment of the present invention is applied. In FIG. 3 subframes are divided to be allocated to the second type UEs. That is, in FIG. 3, the macro UE and the pico UE receive an allocation of different subframes. The second type macro UE uses areas indicated by reference numeral 312 and the second type pico UE uses areas indicated by reference numeral 322. The use of different areas is for distinguishing between UEs using the same frequency band in a case of high inter cell interference. For example, the distinguishment is not applied to the first type UEs in different frequency bands.

Accordingly, in examples 512 and 514 of a transmission by the macro eNB 510 according to an ABS pattern in FIG. 5, data can be transmitted/received to/from the UE according to a pattern 515. Meanwhile, the pico eNBs 520 and 530 can transmit/receive data to/from UEs 522, 524, and 532 according to a pattern 525. In FIG. 5, a signal transmitted by the macro eNB and a signal transmitted by the pico eNB may avoid inter cell interference because the signals are transmitted in any one cell according to the ABS pattern based on a time.

A UE 534, which does not receive a signal transmitted by the macro eNB, can use entire subframes without an application of the pattern 525.

As shown in FIGS. 3, 4, and 5, when various types of UEs are within the heterogeneous network, it is required to manage the inter cell interference. A time division inter-cell-interference management using the ABS pattern is possible between the second type UEs (Rel-10), but it is not possible between the first type UEs (Rel-8, 9). Accordingly, between the first type UE (Rel-8, 9) and the second type UE (Rel-10), a connection between the pico cell and the macro cell may be distinguished since the frequency bands are distinguished as shown in FIG. 3. Such a method may reduce a frequency efficiency and a scheduling efficiency because each communication system uses some of time-frequency bands among all the available time-frequency bands.

When UEs, which are divided into two types of UEs, coexist, that is, when UEs operated by the eICIC scheme to avoid inter-cell-interference coexist, a communication efficiency and a capacity of a communication system may be reduced due to a difference between transmission schemes of respective cells. Accordingly, when a third type UE corresponding to a new type is added, a possibility in which the communication efficiency is reduced becomes high, so that a process is needed to solve the problem. For example, when it is assumed that an embodiment of the third type UE is a Rel-11 UE operated by the CoMP scheme, it is required to design a system such that a reduction of a system efficiency due to a difference between transmission schemes of the CoMP scheme and the eICIC scheme is avoided. Hereinafter, a transmission scheme by which a signal transmission by the Rel-11 UE operated by the CoMP scheme as an embodiment of a new type UE minimally affects the second type UE (for example, Rel-10) operated by the eICIC scheme will be described.

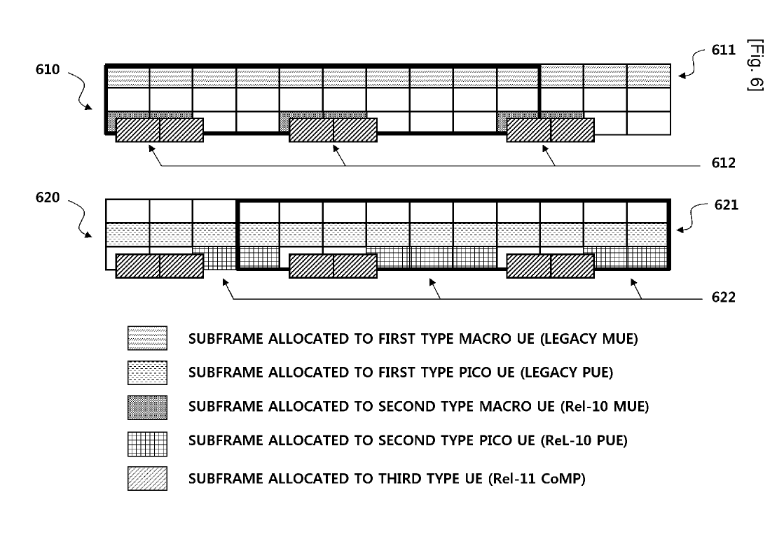

FIG. 6 illustrates an example of allocating resources when three types of UEs coexist according to an embodiment of the present invention. A subframe for the third type UE operated by the CoMP mode may be determined like the determination of the ABS pattern for the eICIC mode described in FIG. 3. At this time, a subframe, which is selected to be operable by the CoMP scheme, may be selected such that the subframe corresponds to a subset of a subframe 612, which is selected such that the macro eNB can transmit a signal in the eICIC mode. The subset may include all or a part of elements of a set. This will be discussed in the following description in more detail.

In a data transmission with the first type UE (legacy, before Rel-9), the macro eNB divides frequency bands and transmits/receives data to/from the divided frequency bands as shown in reference numeral 611 and the pico eNB divides frequency bands and transmits/receives data to/from the divided frequency bands as shown in reference numeral 621.

Meanwhile, in a data transmission with the second type UE (Rel-10), the macro eNB divides time bands and transmits/receives data to/from the divided time bands as shown in reference numeral 612 and the pico eNB divides time bands and transmits/receives data to/from the divided time bands as shown in reference numeral 622. In this case, the second type macro UE and the second type pico UE transmit/receive data in different times so that interference is not generated.

Meanwhile, it may be set such that the macro eNB transmits/receives data to/from the third type (CoMP) UE in the same area as the area 612 in which the macro eNB transmits data to the second type UE or an area which is a subset of the area 612. A transmission/reception of the CoMP scheme corresponds to a scheme of transmitting/receiving a signal to/from the macro eNB and the pico eNB, so that the pico eNB transmits/receives a signal in an area corresponding to the area 612 in a subframe pattern through which the pico eNB transmits a signal.

Accordingly, subframe patterns, which the macro eNB and the pico eNB transmit to perform a CoMP transmission, include the following three types of patterns.

i) subframes 611 and 612 through which only the macro eNB transmits a signal

ii) subframes 621 and 622 through which only the pico eNB transmits a signal

iii) subframes (subframes which are the subset of the subframe 622) through which the macro eNB and the pico eNB transmit a signal

In the above embodiment, a first subframe may not exist according to a construction type of the CoMP transmission subframe.

In an implementation through the CoMP in a limited area (subframe) by a time division scheme as described above, the second type UE (Rel-10) operated by the eICIC can implement the CoMP scheme while generating interference between macro cell and the pico cell. Accordingly, it is possible to allow the second type UE and the third type UE or a higher type UE to access through the same band without separately dividing frequency bands.

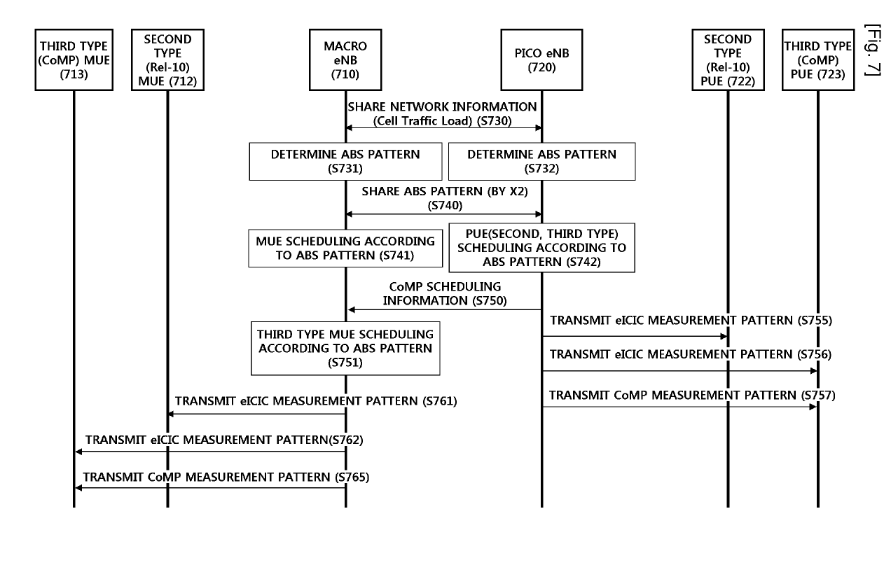

FIG. 7 illustrates a signaling between a UE operated through an eICIC scheme and a UE operated through a CoMP scheme to which an embodiment of the present invention is applied.

In the CoMP scheme, information is transmitted according to a predetermined subframe pattern, and an eNB designs a measurement pattern in consideration of a position of a subframe operated by the CoMP scheme and informs each UE of the designed measurement pattern. A process of transmitting a measurement pattern such that interference is avoided is discussed in the following description in more detail.

The macro eNB 710 and the pico eNB 720 share network information S730. Each eNB determines an ABS pattern S731 and S732. And then, each eNB shares the determined ABS pattern. For example, each eNB can share the ABS pattern by using an X2 interface S740. This is the same as the description of FIG. 4.

The pico eNB 720 performs a scheduling by using the determined ABS pattern in step S742 in order to determine a measurement pattern to be transmitted to the second type UE 722 and the third type UE 723 S742. Further, the pico eNB 720 transmits CoMP scheduling information to the macro eNB 710 S750. The pico eNB having complemented the CoMP scheduling transmits an eICIC measurement pattern to the second type UE 722 and the third type UE 723 S755 and S756. The eICIC measurement pattern refers to a measurement pattern, which enables a UE within the pico eNB to be operable by the eICIC in order not to generate interference with a signal transmitted from the macro eNB. Further, the pico eNB transmits the CoMP measurement pattern to the third type UE, that is, the UE 723 operated by the CoMP scheme S757. The CoMP measurement pattern is obtained from the CoMP transmission/reception pattern included in the subset of the subframe transmitted by the macro eNB described above.

Meanwhile, the macro eNB 710 performs a scheduling for the third type UE by using the CoMP scheduling information S750 generated by the pico eNB 720 and an ABS pattern S751. The macro eNB 710 having completed the scheduling transmits the eICIC measurement pattern to the second type UE 712 and the third type UE 713 S761 and S762. The eICIC measurement pattern refers to a measurement pattern, which enables a UE within the macro eNB to be operable by the eICIC in order not to generate interference with a signal transmitted from the pico eNB. Further, the macro eNB 710 transmits the CoMP measurement pattern to the third type UE 713, that is, the UE operated by the CoMP scheme S765. The CoMP measurement pattern is obtained from the CoMP transmission/reception pattern included in the subset of the subframe transmitted by the macro eNB described above.

FIG. 8 illustrates an example of a transmission between an eNB and a UE according to an ABS pattern in CoMP and eICIC situations to which an embodiment of the present invention is applied. The example is implemented according to the subframe allocation pattern of FIG. 6.

A pattern of a signal transmitted/received from/by the macro eNB 810 corresponds to a pattern 815 or 816. The macro eNB 810 transmits a signal to the second type UE (Rel-10), that is, UEs 812 and 814 transmitting a signal through the eICIC scheme by using the signal pattern 815. The macro eNB 810 transmits a signal to the third type UE, that is, UEs 822 and 832 operated by the CoMP scheme by using the signal pattern 816. A signal transmission/reception to which the signal pattern 816 is applied may be identified through signal patterns 891 and 892.

Meanwhile, patterns of signals transmitted/received from/by the pico eNBs 820 and 830 correspond to signal patterns 825, 826, and 827. The pico eNB 820 transmits a signal to the second type UE (Rel-10), that is, a UE 824 transmitting a signal through the eICIC scheme by using a signal pattern 825. The signal pattern 827 does not generate interference with a signal transmitted from the macro eNB and corresponds to a signal transmission/reception pattern of a UE 834 using entire subframes. The signal pattern 826 corresponds to a pattern by which the pico eNBs 820 and 830 transmit a signal to the third type UE, that is, the UEs 822 and 832 operated by the CoMP scheme. Signal transmissions/receptions to which the signal pattern 826 is applied may be identified through signal patterns 895 and 896.

As described in embodiments of FIGS. 5 to 8, it is possible to set a subframe area for a CoMP transmission based on a pattern selected for a signal transmission of the macro eNB for another type UE such that a CoMP transmission is possible and simultaneously a compatibility with a system operated by another type scheme (for example eICIC) is possible. The CoMP transmission in this specification may be applied to both of a scheme (joint beam forming) in which the macro eNB and the pico eNB simultaneously transmit a signal to a UE and a scheme (coordinated scheduling) in which one eNB of the macro eNB and the pico eNB is randomly selected to transmit a signal to a UE such that one eNB transmits a signal to a UE.

That is, the CoMP transmission is limited to a time axis, but a subset of a macro transmission pattern of the eICIC becomes a CoMP transmission subframe such that the limitation increases a transmission efficiency and reduces interference. Accordingly, a measurement pattern provided to a UE operated by the CoMP scheme is generated based on the CoMP transmission subframe and a subframe identified by the measurement pattern corresponds to the CoMP transmission subframe or a part of the CoMP transmission subframe.

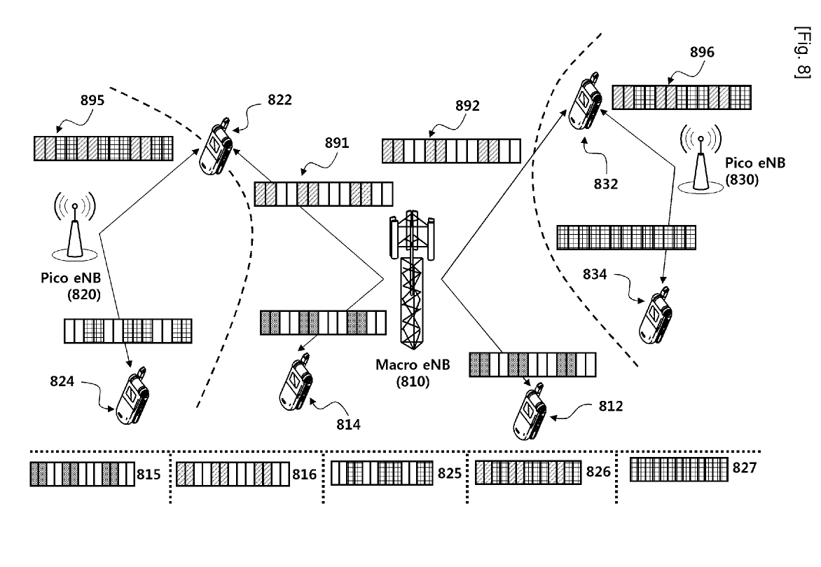

FIG. 9 illustrates a process in which a UE receives a measurement pattern for a CoMP transmission generated by an embodiment of the present invention to measure a channel and a link. The process shows that a UE combined with the pico eNB measures a Reference Signal (RS) provided by the macro eNB and an RS provided by the pico eNB by using a measurement pattern. In FIG. 9, an embodiment of a measurement pattern includes an example of using a CSI (Channel Status Information) measurement pattern. The embodiment of FIG. 9 is described based on the second type (Rel-10, eICIC) transmission subframe and the CoMP (third type) transmission subframe of FIG. 8. A subframe identified by a measurement pattern for each type corresponds to a corresponding type transmission subframe or a part of the corresponding type transmission subframe. However, for convenience of the description, it is assumed that a subframe identified by a measurement pattern and a transmission subframe are the same in FIG. 9. Of course, the measurement pattern may be set as a part of the transmission subframe and transmitted to a UE.

As described in FIG. 8, the pattern transmitted by the macro eNB among subframe patterns transmitted through the eICIC scheme corresponds to the pattern 815 and the pattern transmitted by the pico eNB among subframe patterns transmitted through the eICIC scheme corresponds to the pattern 825. Meanwhile, the CoMP transmission pattern corresponds to the pattern 816 and the pattern 816 is a subset of the pattern 815. Referring to FIG. 9 and based on the pico UE, a CSI measurement pattern storing unit 930 stores the CoMP transmission pattern 816 and the eICIC transmission pattern 825. Meanwhile, receivers 910 and 920 can receive an RS. First, when the receiver 910 receives an RS 951 from the pico eNB, the receiver 910 can identify a pattern corresponding to a subframe number 955 carrying the received RS by using the subframe number carrying the received RS and the CSI measurement pattern stored in the storing unit 930 940. When a subframe number carrying an RS is one of subframes indicated in the pattern 825, that is, when the subframe number is the eICIC transmission subframe, the RS corresponds to a signal transmitted by the pico eNB through the eICIC mode so that the CSI is measured through a single cell mode 961. For the measured CSI, UE reports the CSI or reports information related to a handover in an appointed uplink subframe 970.

Meanwhile, when the subframe number of the RS transmitted by the pico eNB corresponds to one of subframes indicated in the pattern 816, the RS corresponds to the CoMP transmission subframe so that the CSI is measured through the CoMP mode 962. For the measured CSI, UE reports the CSI or reports information related to a handover in an appointed uplink subframe 970.

When a subframe number of an RS 952 transmitted from the macro eNB corresponds to one of subframes indicated in the pattern 816, the RS also corresponds to the CoMP transmission subframe so that the CSI is measured through the CoMP mode 962. For the measured CSI, an appointed uplink subframe reports the CSI or reports information related to a handover 970.

As described above, in the CoMP mode (joint beam forming) in which the macro eNB and the pico eNB simultaneously transmit a signal, the RS 951 from the pico eNB and the RS 952 from the macro eNB are received as shown in the pattern 816. Meanwhile, particularly, in the CoMP mode (coordinated scheduling) in which the pico eNB transmits a signal, the RS 951 is received and the CSI may be measured through the CoMP mode 962 when it is identified that the RS corresponds to the pattern 816 by using the received subframe number.

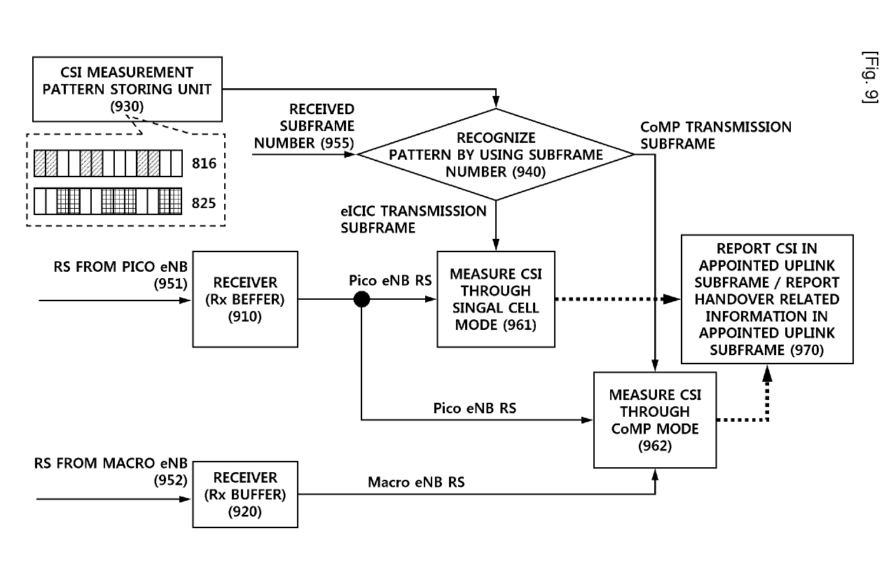

FIG. 10 illustrates an example of a measurement pattern and a CoMP transmission pattern, which can be generated through an embodiment of the present invention.

When applying the subframe of FIG. 6, a subframe which the second type (Rel-10) macro UE transmits corresponds to a pattern 1012 and a subframe which the second type (Rel-10, eICIC) pico UE transmits corresponds to a pattern 1022.

The third type, that is, a subframe performing a CoMP transmission may be a subset of the pattern 1012 and patterns corresponding to the subset may be patterns 1031, 1032, 1033, 1034, and 1035 in consideration of a network state and a CoMP UE state. Further, a measurement pattern provided to a UE for each transmission pattern is a subset of the transmission pattern. A measurement pattern corresponding to a subset of the pattern 1031, which is the CoMP transmission pattern, may be one of patterns 1051. Similarly, a measurement pattern corresponding to a subset of the pattern 1032 may be one of patterns 1052 and a measurement pattern corresponding to a subset of the pattern 1035 may be one of pattern 1055. In FIG. 10, only some of the subsets are illustrated, and another transmission pattern and measurement pattern may be generated.

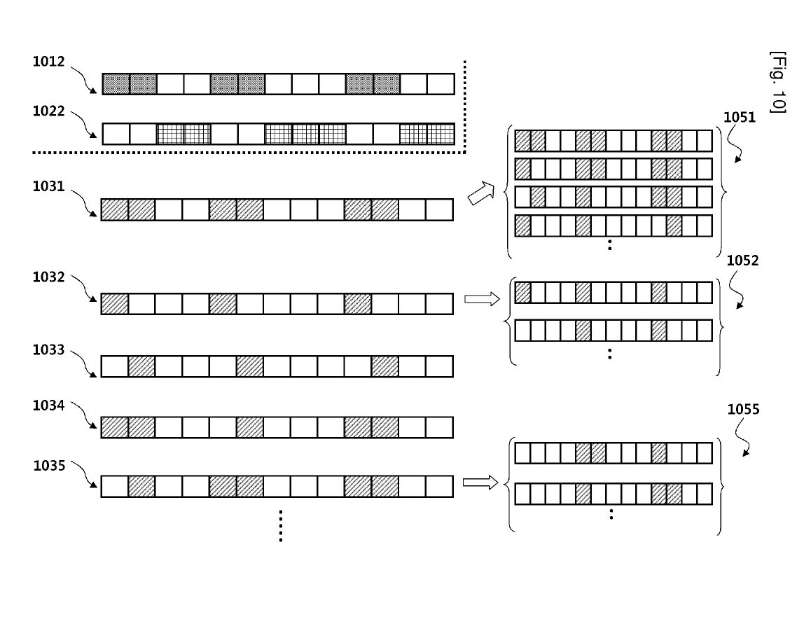

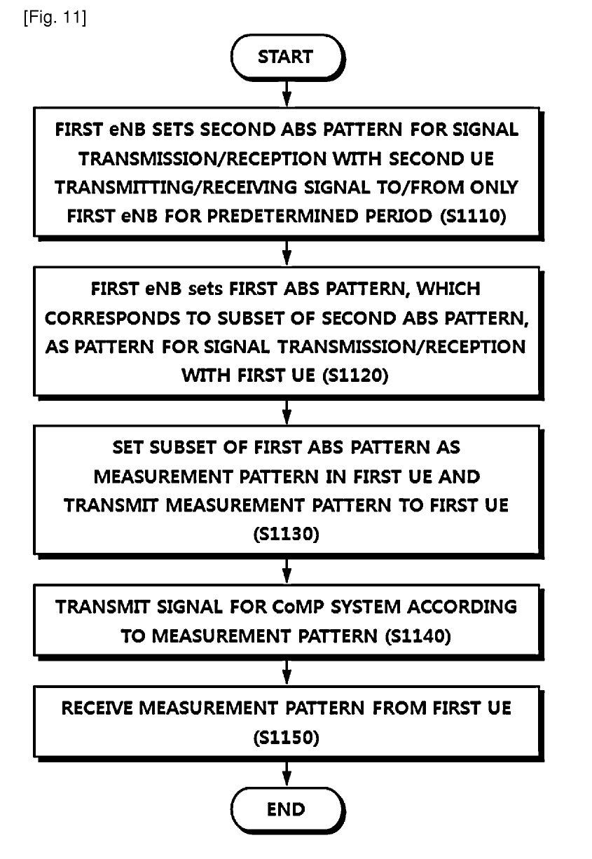

FIG. 11 illustrates a process in which an eNB performing a CoMP transmission according to an embodiment of the present invention generates a measurement pattern to provide the generated measurement pattern to a UE. The eNB of FIG. 11 is described based on the macro eNB.

FIG. 11 is described based on a method in which a first eNB and a second eNB provide CoMP communication to a first UE. An embodiment of the first eNB includes the macro eNB and an embodiment of the second eNB includes the pico eNB. An embodiment of the first UE includes the macro UE operated by the CoMP mode and embodiments of second UE and third UE include UEs operated by the eICIC scheme.

The first eNB sets a second ABS pattern for a signal transmission/reception with the second UE transmitting/receiving a signal to/from only the first eNB for a predetermined period S1110. Further, the first eNB sets a first ABS pattern corresponding to a subset of the second ABS pattern as a pattern for a signal transmission/reception with the first UE S1120. Next, the first eNB generates a subset of the first ABS to be transmitted to the first UE as a measurement pattern and then transmits the measurement pattern to the first UE S1130. The first eNB transmits a signal for the CoMP system according to the measurement pattern S1140 and receives a measurement result from the first UE S1150.

The first eNB receives information on a third ABS pattern generated by the second eNB for a signal transmission/reception with a third UE transmitting/receiving a signal to/from only the second eNB before the first eNB sets the first ABS pattern as the pattern for the signal transmission/reception with the first UE, from the second eNB, and can set the first ABS pattern based on the received information on the third ABS pattern from the second eNB. The second ABS pattern and the third ABS pattern may be set not to include a common subframe. Here, the second ABS pattern may be the eICIC ABS pattern in the macro eNB, the third ABS pattern may be the eICIC ABS pattern in the pico eNB, and the first ABS pattern may be the ABS pattern for the CoMP transmission.

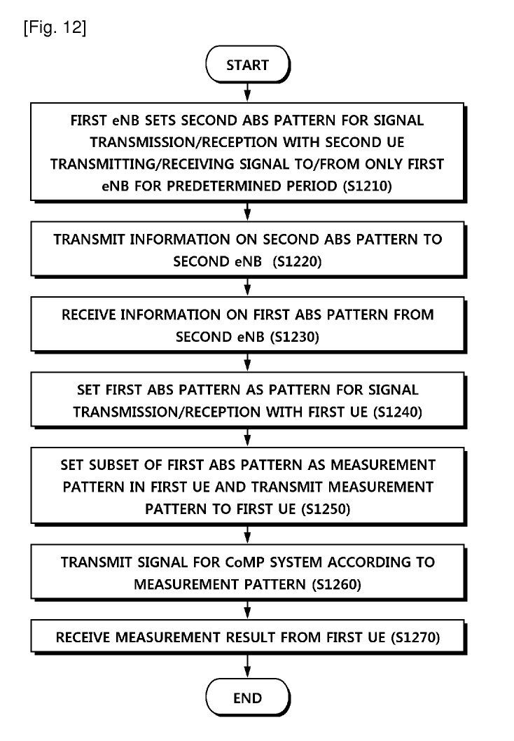

FIG. 12 illustrates a process in which an eNB performing a CoMP transmission according to an embodiment of the present invention generates a measurement pattern to provide the generated measurement pattern to a UE. The eNB of FIG. 12 is described based on the pico eNB.

FIG. 12 is described based on a method in which a first eNB and a second eNB provide a CoMP to a first UE. An embodiment of the first eNB includes the pico eNB and an embodiment of the second eNB includes the macro eNB. An embodiment of the first UE includes the pico UE operated by the CoMP mode and embodiments of second UE and third UE include UEs operated by the eICIC scheme.

The first eNB sets a second ABS pattern for a signal transmission/reception with the second UE transmitting/receiving a signal to/from only the first eNB for a predetermined period S1210. Further, the first eNB transmits information on the second ABS pattern to the second eNB S1220. Next, the first eNB receives information on a first ABS pattern from the second eNB S1230. The first ABS pattern corresponds to a subset of a third ABS pattern for a signal transmission/reception with the third UE transmitting/receiving a signal to/from only the second eNB for a predetermined period.

After receiving the first ABS pattern from the second eNB, the first eNB sets the first ABS pattern as a pattern for a signal transmission/reception with the first UE S1240. Further, the first eNB sets a subset of the first ABS pattern as a measurement pattern and transmits the measurement pattern to the first UE S1250. Next, the first eNB transmits a signal for the CoMP system according to the measurement pattern S1260 and receives a measurement result from the first UE S1270.

The second ABS pattern and the third ABS pattern may be set not to include a common subframe. Here, the second ABS pattern may be the eICIC ABS pattern in the pico eNB, the third ABS pattern may be the eICIC ABS pattern in the macro eNB, and the first ABS pattern may be the ABS pattern for the CoMP transmission.

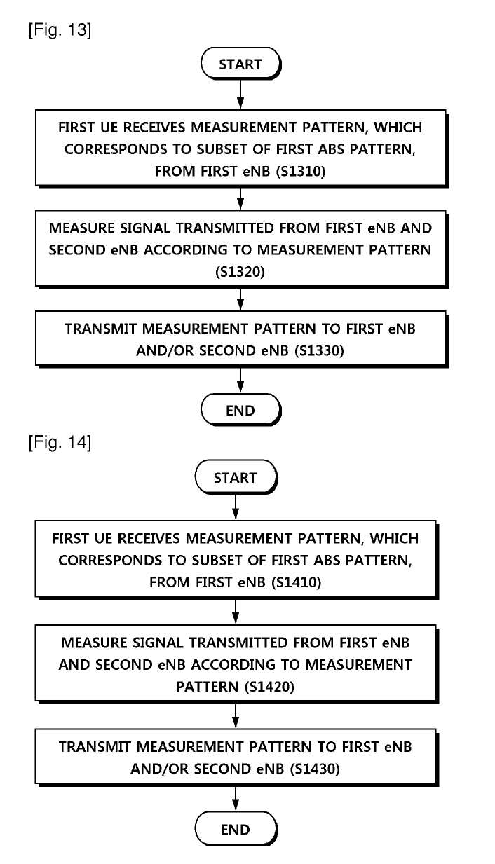

FIG. 13 illustrates that a UE performing a CoMP transmission according to an embodiment of the present invention receives a measurement pattern to measure a signal according to the received measurement pattern. The UE in FIG. 13 is described based on the macro UE.

FIG. 13 is described based on a method in which a first UE performs CoMP communication with a first eNB and a second eNB. An embodiment of the first eNB includes the macro eNB and an embodiment of the second eNB includes the pico eNB. An embodiment of the first UE includes the macro UE operated by the CoMP mode and embodiments of second UE and third UE include UEs operated by the eICIC scheme.

The first UE receives a measurement pattern, which is a subset of a first ABS pattern, from the first eNB S1310. Further, the first UE measures a signal transmitted from the first eNB and the second eNB according to the measurement pattern S1320 and transmits a measurement result to the first eNB and/or the second eNB S1330. The first ABS pattern corresponds to a subset of a second ABS pattern for a signal transmission/reception with the second UE transmitting/receiving a signal to/from only the first eNB for a predetermined period. The second ABS pattern may be an eICIC ABS pattern in the macro eNB and the first ABS pattern may be an ABS pattern for the CoMP transmission.

FIG. 14 illustrates that a UE performing a CoMP transmission according to an embodiment of the present invention receives a measurement pattern to measure a signal according to the received measurement pattern. The UE in FIG. 14 is described based on the pico UE.

FIG. 14 is described based on a method in which a first eNB and a second eNB provide CoMP communication to a first UE. An embodiment of the first eNB includes the pico eNB and an embodiment of the second eNB includes the macro eNB. An embodiment of the first UE includes the pico UE operated by the CoMP mode and embodiments of second UE and third UE include UEs operated by the eICIC scheme.

The first UE receives a measurement pattern which is a sebset of a first ABS pattern from the first eNB S1410. Further, the first UE measures a signal transmitted from the first eNB and the second eNB according to the measurement pattern S1420 and transmits a measurement result to the first eNB and/or the second eNB. At this time, the first ABS pattern may be a subset of a second ABS pattern for a signal transmission/reception with the second UE transmitting/receiving a signal to/from only the second eNB for a predetermined period. Here, the second ABS pattern may be an eICIC ABS pattern in the macro eNB and the first ABS pattern may be an ABS pattern for the CoMP transmission.

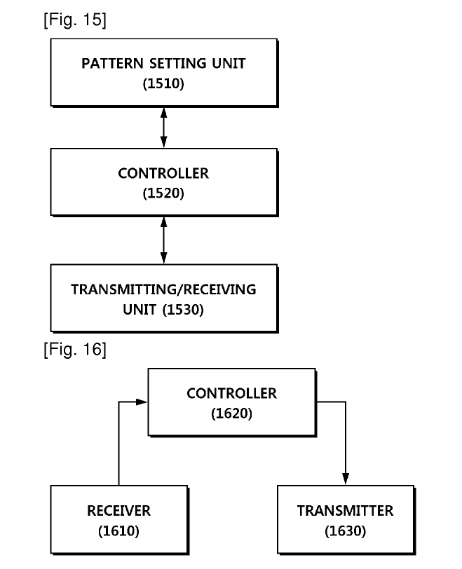

FIG. 15 illustrates a construction of an eNB according to an embodiment of the present invention. The eNB construction may be applied to both of the macro eNB and the pico eNB. Accordingly, each of the two cases is divisibly described.

A total construction includes a pattern setting unit 1510, a controller 1520, and a transmitting/receiving unit 1530. The transmitting/receiving unit 1530 transmits a signal for the CoMP system according to a measurement pattern and the pattern setting unit 1510 generates the measurement pattern. The controller 1520 controls such that the transmitting/receiving unit 1530 selects or sets a subset of an ABS pattern suitable for the CoMP system as a measurement pattern in the UE and transmits the measurement pattern to the UE.

More specifically, two cases of the macro eNB and the pico eNB are divisibly described.

i) When Applying to the Macro eNB, Each of the Following Elements is Operated.

Here, an embodiment of a first eNB is the macro eNB and an embodiment of a second eNB is the pico eNB. An embodiment of a first UE is the macro UE operated by the CoMP mode and embodiments of a second UE and a third UE are UEs operated by the eICIC scheme.

The pattern setting unit 1510 sets a second ABS pattern for a signal transmission/reception with the second UE transmitting/receiving a signal to/from only the first eNB for a predetermined period and sets a first ABS pattern which is a subset of the second ABS pattern as a pattern for a signal transmission/reception with the first UE. Further, the controller 1520 controls such that the transmitting/receiving unit 1530 selects or sets a subset of the first ABS pattern as the measurement in the first UE and transmits information on the measurement pattern to the first UE.

Further, the transmitting/receiving unit 1530 receives information on a third pattern generated by the second eNB for a signal transmission/reception with the third UE transmitting/receiving a signal to/from only the second eNB for a predetermined period, from the second eNB and the controller 1520 can select the second ABS pattern having no common subframe with the third ABS pattern.

In this case, the second ABS pattern and the third ABS pattern may be set not to include a common subframe. Here, the second ABS pattern may be an eICIC ABS pattern in the macro eNB, the third ABS pattern may be an eICIC ABS pattern in the pico eNB, and the first ABS pattern may be an ABS pattern for the CoMP transmission.

ii) when Applying to the Pico eNB, Each of the Following Elements is Operated.

Here, an embodiment of a first eNB is the pico eNB and an embodiment of a second eNB is the macro eNB. A first embodiment of a first UE is the pico UE operated by the CoMP mode and embodiments of a second UE and a third UE are UEs operated by the eICIC scheme.

The pattern setting unit 1510 sets a second ABS pattern for a signal transmission/reception with the second UE transmitting/receiving a signal to/from only the first eNB for a predetermined period and the controller 1520 controls such that the transmitting/receiving unit 1530 transmits information on the second ABS pattern to the second eNB. When the transmitting/receiving unit 1530 receives information on the first ABS pattern, which is a subset of a third ABS pattern for a signal transmission/reception with the third UE transmitting/receiving a signal to/from only the second eNB for a predetermined period, from the second eNB, the pattern setting unit 1510 sets the first ABS pattern as a pattern for a signal transmission/reception with the first UE. Next, the controller 1520 controls such that the transmitting/receiving unit 1530 selects or sets a subset of the first ABS pattern as a measurement pattern in the first UE and transmits the measurement pattern to the first UE. Here, the second ABS pattern and the third ABS pattern may be set not to include a common subframe. Here, the second ABS pattern may be an eICIC ABS pattern in the pico eNB, the third ABS pattern may be an eICIC ABS pattern in the macro eNB, and the first ABS pattern may an ABS pattern for the CoMP transmission.

FIG. 16 illustrates a construction of a UE according to an embodiment of the present invention. The UE construction may be applied to both of the macro UE and the pico UE. Accordingly, the two cases of the macro UE and the pico UE are divisibly described.

A total construction includes a receiver 1610, a controller 1620, and a transmitter 1630. The receiver 1610 receives a measurement pattern which is a subset of an ABS pattern from an eNB, and the controller 1620 measures a signal transmitted from the eNB (first eNB) and another eNB (second eNB) performing the CoMP according to the measurement pattern. The transmitter 1630 transmits a measurement result to the first eNB and/or the second eNB.

More specifically, two cases of the macro UE and the pico UE are divisibly described.

i) When Applying to the Macro UE, the Following Characteristics are Included.

Here, an embodiment of a first eNB is the macro eNB and an embodiment of a second eNB is the pico eNB. An embodiment of a first UE is the macro UE operated by the CoMP mode and embodiments of a second UE and a third UE are UEs operated by the eICIC scheme.

The ABS pattern (first ABS pattern) corresponds to a subset of a second ABS pattern for a signal transmission/reception with the second UE transmitting/receiving a signal to/from only the first eNB for a predetermined period and the measurement pattern includes information indicating a subframe through which a signal is transmitted and received. The second ABS pattern may be an eICIC ABS pattern in the macro eNB and the first ABS pattern may be an ABS pattern for the CoMP transmission.

ii) When Applying to the Pico UE, the Following Characteristics are Included

The ABS pattern (first ABS pattern) corresponds to a subset of a second ABS pattern for a signal transmission/reception with the second UE transmitting/receiving a signal to/from only the second eNB for a predetermined period and the measurement pattern includes information indicating a subframe through which a signal is transmitted and received. The second ABS pattern may be an eICIC ABS pattern in the macro eNB and the first ABS pattern may be an ABS pattern for the CoMP transmission.

As described above, the ABS pattern may include information indicating a subframe through which a signal is transmitted and received, but the ABS pattern is not limited thereto and may be constructed by various methods to indicate a signal transmission/reception.

A transmission of the measurement from the UE to the first eNB or the second eNB includes a transmission to one or two of the two eNBs.

An LTE Rel-10 standard has introduced an eICIC scheme suitable for a heterogeneous network and the network in order to increase radio capacities and efficiently manage resources and an LTE Rel-11 standard desires to introduce a CoMP scheme, which increases communication capacities through cooperative communication between eNBs or cells. In this specification, a method of setting an estimation pattern and transmitting a signal for implementing the CoMP communication in the heterogeneous network while not affecting UE communication adapted to the heterogeneous network using the eICIC scheme introduced by the Rel-10 is proposed.

While the exemplary embodiments have been shown and described, it will be understood by those skilled in the art that various changes in form and details may be made thereto without departing from the spirit and scope of this disclosure as defined by the appended claims and their equivalents. Thus, as long as modifications fall within the scope of the appended claims and their equivalents, they should not be misconstrued as a departure from the scope of the invention itself.

1. A method of transmitting a measurement pattern for a signal transmission/reception in a Coordinated Multi-Point (CoMP) communication system, so as to provide CoMP communication to a first User Equipment (UE) by a first evolved Node-B (eNB) and a second eNB, the method comprising:
setting a second Almost Blank Subframe (ABS) pattern for a signal transmission/reception with a second UE transmitting/receiving a signal to/from only the first eNB for a predetermined period by the first eNB;
setting a first ABS pattern, which corresponds to a subset of the second ABS pattern, as a pattern for a signal transmission/reception with the first UE;
setting the subset of the first ABS pattern as a measurement pattern and transmitting the measurement pattern to the first UE; and
transmitting a signal for the CoMP communication system according to the measurement pattern.

2. The method as claimed in claim 1, further comprising:
receiving information on a third ABS pattern generated by the second eNB for a signal transmission/reception with a third UE transmitting/receiving a signal to/from only the second eNB for a predetermined period from the second eNB,
wherein the second ABS pattern and the third ABS pattern do not include a common subframe.

3. The method as claimed in claim 1, wherein the ABS pattern includes information indicating a subframe through which a signal is transmitted and received.

4. A method of transmitting a measurement pattern for a signal transmission/reception in a Coordinated Multi-Point (CoMP) communication system, so as to provide CoMP communication to a first User Equipment (UE) by a first evolved Node-B (eNB) and a second eNB, the method comprising:
setting a second Almost Blank Subframe (ABS) pattern for a signal transmission/reception with a second UE transmitting/receiving a signal to/from only the first eNB for a predetermined period by the first eNB;
transmitting information on the second ABS pattern to the second eNB;
receiving information on a first ABS pattern, which corresponds to a subset of a third ABS pattern for a signal transmission/reception with a third UE transmitting/receiving a signal to/from only the second eNB for a predetermined period, from the second eNB and setting the received first ABS pattern as a pattern for a signal transmission/reception with the first UE;
setting a subset of the first ABS pattern as a measurement pattern and transmitting the measurement pattern to the first UE; and
transmitting a signal for the CoMP communication system according to the measurement pattern.

5. The method as claimed in claim 4, wherein the ABS pattern includes information indicating a subframe through which a signal is transmitted and received.

6. A method of receiving a measurement pattern for a signal transmission/reception in a Coordinated Multi-Point (CoMP) communication system, so as to perform CoMP communication with a first evolved Node-B (eNB) and a second eNB by a first User Equipment (UE), the method comprising:
receiving a measurement pattern, which corresponds to a subset of a first Almost Blank Subframe (ABS) pattern, from the first eNB; and
measuring a signal transmitted from the first eNB and the second eNB according to the measurement pattern and transmitting a measurement result to one or more eNBs of the first eNB and the second eNB,
wherein the first ABS pattern corresponds to a subset of a second ABS pattern for a signal transmission/reception with a second UE transmitting/receiving a signal to/from only the first eNB for a predetermined period.

7. The method as claimed in claim 6, wherein the measurement pattern includes information indicating a subframe through which a signal is transmitted and received.

8. A method of receiving a measurement pattern for a signal transmission/reception in a Coordinated Multi-Point (CoMP) communication system, so as to perform COMP communication with a first evolved Node-B (eNB) and a second eNB by a first User Equipment (UE), the method comprising:
receiving a measurement pattern, which corresponds to a subset of a first Almost Blank Subframe (ABS) pattern, from the first eNB; and
measuring a signal transmitted from the first eNB and the second eNB according to the measurement pattern and transmitting a measurement result to one or more eNBs of the first eNB and the second eNB,
wherein the first ABS pattern corresponds to a subset of a second ABS pattern for a signal transmission/reception with a second UE transmitting/receiving a signal to/from only the second eNB for a predetermined period.

9. The method as claimed in claim 8, wherein the measurement pattern includes information indicating a subframe through which a signal is transmitted and received.

10. An evolved Node-B (eNB) in a wireless communication system comprising a first evolved Node-B (eNB) and a second eNB, which provide Coordinated Multi-Point (CoMP) communication to a first User Equipment (UE), the eNB comprising:
a transmitting/receiving unit for transmitting a signal for a CoMP communication system according to a measurement pattern;
a pattern setting unit for setting a second Almost Blank Subframe (ABS) pattern for a signal transmission/reception with a second UE transmitting/receiving a signal to/from only the first eNB for a predetermined period and setting a first ABS pattern, which corresponds to a subset of the second ABS pattern, as a pattern for a signal transmission/reception with the first UE; and
a controller for controlling such that the transmitting/receiving unit sets a subset of the first ABS pattern as a measurement pattern and transmitting information on the measurement pattern to the first UE,
wherein the ABS pattern includes information indicating a subframe through which a signal is transmitted and received.

11. The eNB as claimed in claim 10, wherein the transmitting/receiving unit receives information on a third ABS pattern generated by the second eNB for a signal transmission/reception with a third UE transmitting/receiving a signal to/from only the second eNB for a predetermined period from the second eNB and the controller selects the second ABS pattern having no common subframe with the third ABS pattern.

12. An evolved Node-B (eNB) comprising a first eNB and a second eNB, which provide a Coordinated Multi-Point (CoMP) to a first User Equipment (UE) in a wireless communication system, the eNB comprising:
a transmitting/receiving unit for transmitting a signal for a CoMP system according to a measurement pattern;
a pattern setting unit for setting a second Almost Blank Subframe (ABS) pattern for a signal transmission/reception with a second UE transmitting/receiving a signal to/from only the first eNB for a predetermined period; and
a controller for controlling such that the transmitting/receiving unit transmits information on the second ABS pattern to the second eNB,
wherein the transmitting/receiving unit receives information on a first ABS pattern, which corresponds to a subset of a third ABS pattern for a signal transmission/reception with a third UE transmitting/receiving a signal to/from only the second eNB for a predetermined period from the second eNB and the pattern setting unit sets the first ABS pattern as a pattern for a signal transmission/reception with the first UE, the controller controls such that the transmitting/receiving unit sets a subset of the first ABS pattern as a measurement pattern and transmits the measurement pattern to the first UE, and the ABS pattern includes information indicating a subframe through which a signal is transmitted and received.

13. A User Equipment (UE) performing Coordinated Multi-Point (CoMP) communication with a first evolved Node-B (eNB) and a second eNB, the User Equipment (UE) comprising:
a receiver for receiving a measurement pattern, which corresponds to a subset of a first Almost Blank Subframe (ABS) pattern, from the first eNB;
a controller for measuring signals transmitted from the first eNB and the second eNB according to the measurement pattern; and
a transmitter for transmitting a measurement result to one or more eNBs of the first eNB and the second eNB,
wherein the UE is a first UE, the first ABS pattern corresponds to a subset of a second ABS pattern for a signal transmission/reception with a second UE transmitting/receiving a signal to/from only the first eNB for a predetermined period, and the measurement pattern includes information indicating a subframe through which a signal is transmitted and received.

14. A User Equipment (UE) performing Coordinated Multi-Point (CoMP) communication with a first evolved Node-B (eNB) and a second eNB, the UE comprising:
a receiver for receiving a measurement pattern, which corresponds to a subset of a first Almost Blank Subframe (ABS) pattern, from the first eNB;
a controller for measuring signals transmitted from the first eNB and the second eNB according to the measurement pattern; and
a transmitter for transmitting a measurement result to one or more eNBs of the first eNB and the second eNB,
wherein the UE is a first UE, the first ABS pattern corresponds to a subset of a second ABS pattern for a signal transmission/reception with a second UE transmitting/receiving a signal to/from only the second eNB for a predetermined period and the measurement pattern includes information indicating a subframe through which a signal is transmitted and received.
